(19) United States
(12) Patent Application Publication
(10) Pub. No.: US 2025/0092478 A1
(43) Pub. Date: Mar. 20, 2025

(54) GAS COMPRESSION IN HYDROGEN-BASED DIRECT REDUCTION

(71) Applicant: Primetals Technologies Austria GmbH, Linz (AT)

(72) Inventors: Robert MILLNER, Loosdorf (AT); Hans Thomas SATTLER, Linz (AT)

(21) Appl. No.: 18/294,151

(22) PCT Filed: Aug. 1, 2022
(86) PCT No.: PCT/EP2022/071573

§ 371 Date: Jan. 31, 2024

(30) Foreign Application Priority Data
Aug. 2, 2021 (EP) 21189193.2

(51) Int. Cl. C21B 13/00

(52) U.S. Cl. CPC C21B 13/0073

(57) ABSTRACT

A direct reduction plant that includes a catalytic reformer and/or a gas furnace and a gas compression plant having one or more compressors. The gas compression plant includes at least one compression stage, and wherein at least one gas cooler for compressed gas. A direct introduction line for introducing gas directly into the reformer and/or into the gas furnace proceeds from the gas compression plant or the gas cooler. A bypass is provided at least at one of the compressors. During operation, at least a portion of the compressed gas is cooled and compressed gas from the gas compression plant or the gas cooler is introduced directly into the reformer and/or the gas furnace. At least intermittently, a portion of a gas compressed by a compressor is returned by means of the bypass.

### TECHNICAL FIELD

The application relates to a direct reduction plant comprising a catalytic reformer and/or a gas furnace and a gas compression plant having one or more compressors, wherein the gas compression plant comprises at least one compression stage, and wherein at least one gas cooler for compressed gas is present. It also relates to a method for operating a direct reduction plant comprising a catalytic reformer and/or a gas furnace and a gas compression plant having one or more compressors, wherein the gas compression plant comprises at least one compression stage, and wherein at least one gas cooler for compressed gas is present, wherein reduction gas is introduced into a reduction unit after gas compression.

### PRIOR ART

The reduction of ore that contains metal oxide, for example iron oxide, by means of direct reduction in a reduction unit, such as a reduction shaft, using reduction gas is known. In the case of conventional methods presently used on an industrial scale, the reduction gas is predominantly based on natural gas. A large amount of carbon dioxide CO2 accumulates in the process, this being undesirable for reasons relating to environmental policy, among other things. To avoid the discharge of CO2 during direct reduction, the use of hydrogen as reduction gas is known. Hydrogen can be used as single reduction gas or in combination with other gases, for example natural-gas-based reduction gases. The larger the fraction of CO2-neutral hydrogen H2 in the reduction gas, the less CO2 is emitted.

At present, however, the amount of hydrogen economically available is low, and therefore it is scarcely possible to ensure operation on a sustained basis only using hydrogen H2 as reduction gas. Accordingly, the main focus of attention is on the use of hydrogen H2 at least intermittently together with other gases, for example natural-gas-based reduction gases.

In principle, it is therefore desirable to design and operate direct reduction plants such that they can function both using natural-gas-based reduction gas and using hydrogen and mixtures of natural-gas-based reduction gas and hydrogen. In that case, production can be carried out in different ways depending on the availability of the various reduction gases.

During operation of direct reduction plants, the reduction gas or the reduction gas precursor must be compressed before the reduction gas is introduced into the reduction unit in order to overcome the pressure losses in the plant. During the compression, energy is introduced into the gas to be compressed, as a result of which its temperature also rises-compressors are consequently subjected to thermal loading. Usually, the compressors are cooled by spraying water into the gas to be compressed or into the compressor, among other things.

Compared to other reduction gases, hydrogen has a considerably lower density, a low molecular weight and high speed of sound. This has the effect that different requirements are placed on compressors that are intended to be suitable for the economic compression of hydrogen than on compressors that are intended to process denser gases of higher molecular weight and lower speed of sound—for example natural-gas-based reduction gases, the molecular weight of which is also in a relatively narrow range. This must be taken into consideration when direct reduction plants are being operated in such a way that they can function both using natural-gas-based reduction gas and using hydrogen and mixtures of natural-gas-based reduction gas and hydrogen. If the compressors suitable for economic compression of hydrogen are also intended to be capable of economically compressing other gases, and therefore are intended to cover a wide range of molecular weights—this is the case, for example, if gas mixtures of hydrogen with other gases are used—these different requirements must be taken into consideration. Accordingly, there is a need to adapt the gas compression system of existing direct reduction plants to an increasing fraction of hydrogen in gas mixtures with other gases, for example natural-gas-based reduction gases.

Moreover, the direct reduction of oxidic ores/pellets is endothermic when hydrogen is used. In order to be able, for economic direct reduction with high productivity, to cover thermodynamically necessary heat requirements and ensure temperature conditions in the reduction shaft, the intention in the event of hydrogen-based operation is to introduce a higher specific gas amount—than is necessary for the reduction—of reduction gas as carrier of heat energy into the reduction unit, in order to compensate cooling owing to the endothermic reactions.

These higher amounts of reduction gas, which can consist of a high fraction or entirely of hydrogen, can be recycled after it has passed through the reduction unit, possibly with heating. Therefore, for hydrogen use, larger volume flows of reduction gas must be compressed compared to the conventional mode of operation with exothermic direct reduction using other gases, for example natural-gas-based reduction gases. Accordingly, there is a need to adapt the gas compression system of existing direct reduction plants to an increasing fraction of hydrogen in gas mixtures with other gases, for example natural-gas-based reduction gases.

Moreover, in the event of planned use of hydrogen as sole reduction gas, there are operating situations, such as the startup and heating up of a direct reduction plant, in which it is not hydrogen but another gas—for example nitrogen or other inert gases—with a considerably higher molecular weight than hydrogen that needs to be delivered. Therefore, different requirements are also placed on compressors that are intended to be suitable for the economic compression of such gases than on compressors that are intended to process hydrogen.

Overall, the problem therefore arises that, on account of the different gases to be compressed, gas compression should be economically possible over a wide range of gas densities, molecular weights and speeds of sound, wherein possibly existing gas compression plants hitherto used for natural-gas-based reduction gas ought to be at least partially usable again.

As reduction using hydrogen gains in importance, the presence of water vapor in the reduction gas has an increasingly disadvantageous effect, since it reduces the reduction potential of the reduction gas. In the case of recirculation of a portion of the top gas removed from the reduction unit, this problem is made worse by a water vapor content in the top gas which increases as the hydrogen fraction in the reduction gas rises—and thus as the natural gas use falls. It is also made worse by the fact that, to cool the compressors, water is sprayed into the gas to be compressed, the necessary cooling power for the top-gas scrubber rises owing to the higher amount of gas and higher water vapor content, and it is necessary to set the reduction gas quality, that is to say the ratio of reductants to oxidants (CO+H2)/(CO2+H2O) and H2/H2O for controlling the reformation of natural gas with hydrogen (CH4+H2O→CO+3H2), for the reduction and the product quality.

### SUMMARY OF THE INVENTION

### Technical Problem

The object of the present invention is to present a solution for at least some of the aforementioned problems.

### Technical Solution

The object is achieved by a direct reduction plant comprising a catalytic reformer and/or a gas furnace and a gas compression plant having one or more compressors, wherein the gas compression plant comprises at least one, preferably at least two compression stages, and wherein at least one gas cooler for gas compressed in the gas compression plant is present, preferably at least downstream of the last compression stage as viewed in the direction of the gas flow,
characterized in that
a direct introduction line for introducing compressed gas directly into the reformer and/or into the gas furnace proceeds from the gas compression plant or the gas cooler,
and, at least at one of the compressors, a bypass for returning at least a portion of the gas compressed by the compressor to a suction-side gas introduction line of the relevant compressor is provided.

It is possible for one gas cooler or multiple gas coolers to be present, for example one gas cooler downstream of each compression stage if multiple compression stages are present. The gas cooler can be used to condense hydrogen out from the gas that was compressed. Accordingly, the gas cooler makes it possible to reduce the water vapor content in the reduction gas and/or to set the reduction gas quality.

At least at one of the compressors, a bypass for returning at least a portion of the gas compressed by the compressor to a suction-side gas introduction line of the relevant compressor is provided. As viewed in the direction of the gas flow, the bypass branches off from the gas removal line downstream of the compressor and leads into the gas introduction line upstream of the compressor, that is to say on the suction side—the compressor which has the branch downstream of it is the “relevant compressor”.

The direct reduction plant also comprises at least one reduction unit. It serves for the direct reduction of ore that contains metal oxide, for example contains iron oxide. The reduction unit may for example comprise a reduction shaft, for example for fixed-bed operation, or a fluid-bed reactor or a fluidized-bed reactor. In this context, the “ore” also includes feedstocks that contain metal oxide and are obtained by preparing ore, such as pellets, lump ore, fine ore, sinter, oxide briquettes, remet.

The direction of the gas flow—also referred to as gas flow direction—is in the direction of the reduction unit, since it is ultimately the reduction unit of the direct reduction plant that is to be supplied with reduction gas.

According to a variant, the direct reduction plant comprises a catalytic reformer for producing reduction gas—or reduction—gas precursor gas, from which reduction gas is produced taking further measures, such as admixing additional gases, or heating—; the reduction gas is introduced into the reduction unit in order there to perform the direct reduction reactions for producing sponge iron.

According to another variant, the direct reduction plant comprises a gas furnace; in this case, gas heated in the gas furnace is reduction gas or reduction-gas precursor gas. A gas furnace is a device for heating gas, for example process gas, using hot flue gas from the combustion of top gas or natural gas, or by means of electrical heating.

The direct reduction plant may also comprise a catalytic reformer and a gas furnace. In this case, the gas furnace is preferably connected upstream of the catalytic reformer in the direction of the gas flow.

According to the invention, gas—that is, compressed gas—exiting from the gas compression plant or the gas cooler for compressed gas is introduced directly into the catalytic reformer for reformation in order to produce reduction gas or reduction-gas precursor gas, and/or into the gas furnace. Direct introduction is to be understood to mean that the introduction is effected without the amount of CO2 being reduced by removing CO2; that is, the introduction is effected with preservation of the amount of CO2. Direct introduction is therefore effected without taking measures for reducing the amount of CO2 in the compressed gas. The direct introduction is performed without devices for removing CO2 from the compressed gas. If appropriate, direct introduction also involves an increase in temperature, for example in a gas-gas heat exchanger; the direct introduction is then performed using temperature increasing devices. Direct introduction therefore does not involve any CO2 removal—for example by means of chemical scrubbing—such as MEA monoethanolamines, KM CDR Kansai Mitsubishi carbon dioxide recovery—, VPSA vacuum pressure swing absorption or PSA pressure swing absorption, and therefore introduction takes place without removing CO2.

The direct introduction is effected via the direct introduction line, which proceeds from the gas compression plant or the gas cooler, for introducing gas directly into the reformer and/or into the gas furnace.

If the gas cooler is arranged downstream of the last compression stage as viewed in the direction of the gas flow, the direct introduction proceeds from the gas cooler; if the gas cooler is not arranged downstream of the last compression stage as viewed in the direction of the gas flow, the direct introduction proceeds from the last compression stage as viewed in the direction of the gas flow. If the gas cooler is arranged downstream of the last compression stage as viewed in the direction of the gas flow, it is not considered to be part of the gas compression plant; if the gas cooler is not arranged downstream of the last compression stage as viewed in the direction of the gas flow, it is considered to be part of the gas compression plant.

In any case, compressed gas can be introduced directly into the reformer and/or into the gas furnace by means of the direct introduction line.

### Advantageous Effects of the Invention

The gas compression plant comprises one or more compressors. A compressor has a gas introduction line—for gas that is to be compressed—and a gas removal line—for compressed gas. A gas stream can be conducted past the compressor back to the suction side by means of a bypass. According to the invention, at least at one of the compressors there is provided a bypass, which connects its gas introduction line and gas removal line, for returning at least a portion of the gas compressed by the compressor. As viewed in the direction of the gas flow, the bypass branches off from the gas removal line downstream of the compressor and leads into the gas introduction line upstream of the compressor, that is, on the suction side.

This bypass enables exact closed-loop control of the amount of reduction gas if the desired amount of reduction gas does not match the delivery rate of the compressors. In the event of closed-loop control of the speed of one compressor or multiple compressors, the situation may arise in which the minimum rotational speed for the compressor must not be undershot—for example 30% of the rated speed-because of the compressor lubrication and/or motor lubrication or compressor cooling and/or motor cooling. If a compressor is fundamentally designed such that it can compress amounts of gas that are necessary for pure hydrogen operation, operation even at the minimum speed possibly still delivers excessively high volumes in the case of mixtures of hydrogen with, for example, natural gas; in order to nevertheless not deliver too much gas while maintaining the minimum speed, it is possible to use the bypass to return a portion of the compressed gas—and feed it into the gas introduction line on the suction side—and thus obtain a variation in the delivery rate. The fraction of compressed gas that is returned is preferably returned unchanged, the returned gas then therefore corresponding to the compressed gas branched off from the gas removal line in the event of suction-side feeding into the gas introduction line.

At least one gas cooler preferably has a bypass. A gas cooler has a gas introduction line and a gas removal line. The bypass can be used to conduct a gas stream past the gas cooler without passing through it. As viewed in the direction of the gas flow, the bypass line branches off from the gas introduction line upstream of the gas cooler and leads into the gas removal line downstream of the gas cooler. A gas cooler cools the gas, the aim being to condense water vapor as a result of the cooling; it could also be referred to as gas cooling condenser or condenser.

In this way, the water vapor content in the reduction gas can be easily varied. The gas flowing through this bypass line is not cooled in the gas cooler. Depending on how a gas stream is subdivided in terms of passing through the gas cooler or this bypass line, the water vapor content can be different after unification. If, for example, a gas stream is subdivided 90% into a first portion passing through the gas cooler and 10% into a second portion passing through the bypass line, after the two partial streams are reunified downstream of the gas cooler there is a lower water vapor content than if the ratios were to be reversed-since more water condenses out in the gas cooler and is removed from the gas stream in the first case than in the second case.

In pure hydrogen H2 operation, a portion or the entire amount is conducted via the gas cooler, in order to set the water vapor content in the reduction gas to a setpoint range, preferably in the range of 0.5% by volume or higher, particularly preferably 3% by volume or higher, through to 10% by volume, particularly preferably through to less than 8% by volume, very particularly preferably through to less to 6% by volume. If appropriate, a portion is also conveyed via the bypass of the gas cooler.

In operation using mixtures of natural gas and hydrogen, a portion or the entire amount is conducted via the gas cooler, in order to set the water vapor content in the reduction gas to a setpoint range, preferably in the range of 0.5% by volume or higher, particularly preferably 3% by volume or higher, through to 10% by volume, particularly preferably through to less than 8% by volume, very particularly preferably through to less to 6% by volume. If appropriate, a portion is also conveyed via the bypass of the gas cooler.

In the direct reduction plant according to the invention, one or more devices for spraying water into a gas stream to be compressed or into the compressor are preferably also present; they can be used to cool the compressors and/or set the water vapor content.

The gas compression plant preferably has a device for the open-loop and/or closed-loop control of the water vapor content in the gas stream exiting the gas compression plant.

Thus, a device may for example act on the distribution of a gas stream between the gas cooler and its bypass, or on a device for spraying water into a gas stream to be compressed or into the compressor, or on the addition of vapor into a gas stream exiting a compressor, or on the coolant temperature of the gas cooler—in the case of gas coolers operated using coolant, for example cooling water, the coolant temperature influences the water vapor content—or it can—for example via corresponding sensors, data processing devices, actuators, valves etc.—receive and/or process and/or emit associated open-loop and/or closed-loop control signals.

A device for the open-loop and/or closed-loop control of the gas stream exiting the gas compression plant—the gas stream being introduced for example into a catalytic reformer or the gas furnace—by means of flow measurements of this gas stream and acting on one or more compressors, preferably variable-frequency-drive positive-displacement compressors, is preferably also present.

The gas compression plant comprises one or more compressors. All the compressors of the gas compression plant are preferably positive-displacement compressors. It is preferred if they are rotary lobe compressors, although they may also be other types, such as reciprocating compressors or screw compressors, rotary blade piston compressors or Wankel-type compressors. Positive-displacement compressors adapt to changes in the operating conditions, such as composition, inlet and outlet gas temperature, etc., without problems, making corresponding changes until the use limits are reached, although the outlet pressure does not essentially depend on the gas composition and thus the speed of sound as in the case of radial compressors.

Positive-displacement compressors generally have sound suppressors. At least one positive-displacement compressor preferably has a sound suppressor. With preference, at least one of the gas coolers is integrated in a sound suppressor of a positive-displacement compressor. The fact that only one pressure vessel is necessary reduces the space requirement and leads to lower costs.

The gas compression plant preferably has one or more variable-frequency-drive positive-displacement pumps in at least one compression stage.

A variable-frequency-drive positive-displacement compressor has speed control via VFD control; the delivered volume flow of the gas is substantially proportional to the speed of the compressor that is controlled in closed-loop fashion via the frequency of the AC voltage. A variable-frequency-drive positive-displacement compressor can be operated at various speeds which can be changed easily by setting the frequency using variable-frequency drives. Generally, positive-displacement compressors are operated at a fixed speed, or within a narrow range of speeds; they can therefore also only be operated in a way that makes economic sense for a narrow range of gas densities, molecular weights, speeds of sound and gas volume flows. A variable-frequency-drive positive-displacement compressor, by contrast, owing to the variable-frequency drive enables operation in a comparatively broad spectrum of speeds and can therefore be operated in a way that makes economic sense for a broader range of gas volume flows, gas densities, molecular weights and speeds of sound.

The presence of a variable-frequency-drive positive-displacement compressor thus makes it possible to react to an increasing hydrogen content in the reduction gas, since its operation can be easily adapted in terms of changes to gas densities, molecular weights, speeds of sound and gas volume flows. A continuous increase in the hydrogen content or the gas volume flows is possible, since all that is necessary to adapt is to increase the compression frequency by means of open-loop and/or closed-loop control of the variable-frequency drive.

Compressors possibly already present in the compression stages can be preserved and supplemented with variable-frequency-drive positive-displacement compressors. In this way, it is possible to easily, inexpensively and resource-efficiently adapt existing direct reduction plants functioning using natural-gas-based reduction gas to hydrogen operation.

The one or more variable-frequency-drive positive-displacement compressors may be connected to one another or to other compressor types in parallel or in series in the compression stages.

Variation of the delivery rate using variable-frequency drives saves more power than variation of the delivery rate using a bypass.

Variation using a bypass and variation using variable-frequency drives can, however, readily supplement one another, for example in transition regions in which the closed-loop frequency control cannot be down-regulated further owing to minimum speed restrictions, or when volume delivery units are being started up.

Another subject of the present invention is a method for operating a direct reduction plant comprising a reduction unit, a catalytic reformer and/or a gas furnace and a gas compression plant, which is intended for providing compressed gas by gas compression and has one or more compressors, wherein the gas compression plant comprises at least one compression stage, and wherein at least one gas cooler for gas compressed in the gas compression plant is present, wherein reduction gas is introduced into the reduction unit after gas compression, characterized in that at least a portion of the compressed gas is cooled, preferably at least after the last gas compression as viewed in the direction of the reduction unit, and compressed gas from the gas compression plant or the gas cooler is introduced directly into the reformer and/or the gas furnace, and, at least intermittently, a portion of a gas compressed by a compressor is returned to a suction-side gas introduction line of the relevant compressor by means of the bypass.

Such a method makes it possible, for example, to operate a direct reduction plant as described above.

A portion of a gas compressed by a compressor is returned to the suction side of the compressor by means of a bypass.

According to the method, in the gas compression plant gas is compressed, and in the process compressed gas is generated. The gas compression plant serves to provide compressed gas by virtue of gas compression. The compressed gas is cooled in the gas cooler. The compressed gas is reduction gas or reduction-gas precursor gas.

With preference, at least intermittently a portion of a compressed gas conducted to a gas cooler is conveyed past the gas cooler by means of the bypass.

For example, of 100 m³ of compressed gas, a portion of 80 m³ is cooled in a gas cooler, while 20 m³ is not cooled; this 20 m³ is conducted past the gas cooler that cools the 80 m³, for example via a bypass.

With preference, the water vapor content in the gas stream obtained during the gas compression is controlled in open-loop and/or closed-loop fashion, preferably by spraying water into a gas stream to be compressed or into a compressor.

It is possible to set the water vapor content by means of devices for spraying water into a gas stream to be compressed or into a compressor; therefore, such devices can be used not only to cool the compressors, but also for the open-loop and/or closed-loop control of the water vapor content.

Gas compression preferably takes place in at least one compression stage by means of a variable-frequency-drive positive-displacement compressor.

### BRIEF DESCRIPTION OF THE DRAWINGS

The present invention will be described by way of example below on the basis of several schematic figures.

FIG. 1 schematically shows a direct reduction plant according to the invention.

FIG. 2 schematically shows details of a gas compression plant.

FIG. 3 schematically shows the integration of a gas cooler in a sound suppressor.

### DESCRIPTION OF THE EMBODIMENTS

### Examples

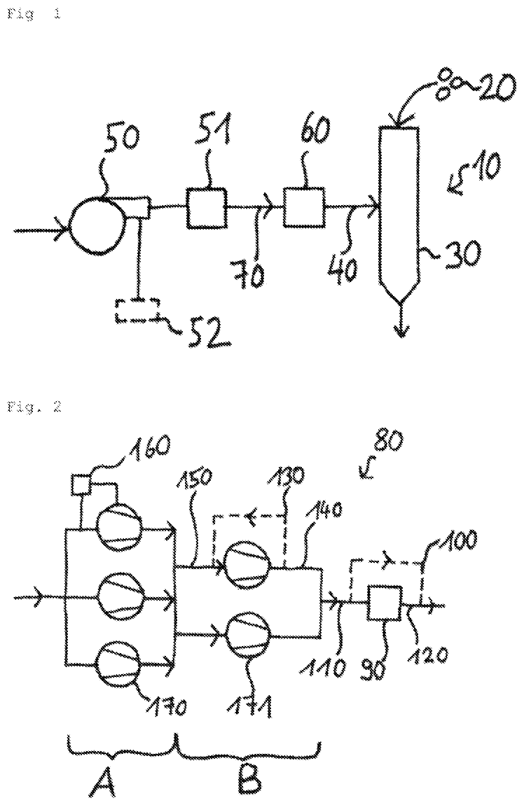

FIG. 1 schematically shows a direct reduction plant 10. Material—for example ore, pellets—containing metal oxide—in the case illustrated, containing iron oxide—20 is introduced into a reduction unit, in order to be reduced there by means of reduction gas. During operation of the direct reduction plant 10, reduction gas is introduced into the reduction unit 30 after gas compression. A reduction gas line 40 through which reduction gas is introduced into the reduction unit 30—in the present case a reduction shaft—is illustrated. A gas compression plant 50 ensures that the reduction gas or its precursor is compressed, in order to have the pressure required for carrying out the direct reduction in the direct reduction plant 10. For reasons of clarity, in FIG. 1 recirculation lines for top gas, among other things, have not been illustrated. According to the invention, the gas compression plant 50 comprises at least one compression stage. At least one gas cooler 51 for gas compressed in the gas compression plant 50 is present in the direct reduction plant, in this case downstream of the last compression stage as viewed in the direction of the gas flow in the direction of the reduction unit 30. An optionally present device 52 for the open-loop and/or closed-loop control of the water vapor content in the gas stream exiting the gas compression plant 50 is also schematically illustrated.

An existing catalytic reformer 60, into which gas compressed in the gas compression plant is introduced directly via the direct introduction line 70, is also illustrated. In principle, the element with the reference sign 60 could also be a gas furnace.

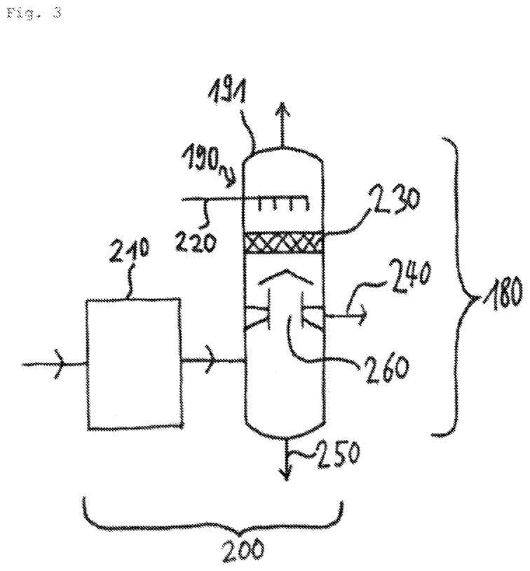

The detail according to the invention that, at least at one of the compressors, a bypass for returning at least a portion of the gas compressed by the compressor to a suction-side gas introduction line of the relevant compressor is provided, is illustrated in FIG. 2.

FIG. 2 shows a schematic view of a gas compression plant 80 and a gas cooler 90. There are two compressors A and B, with A comprising three compressors and B comprising two compressors. A gas cooler 90 is present downstream of the last compression stage as viewed in the direction of the gas flow-illustrated by the arrow heads. Optionally, the gas cooler 90 has a bypass 100, illustrated in dashed line. The bypass 100 can be used to conduct a gas stream past the gas cooler 90 without passing through it. As viewed in the direction of the gas flow, the bypass line 100 branches off from the gas introduction line 110 upstream of the gas cooler 90 and leads into the gas removal line 120 downstream of the gas cooler. During operation of the direct reduction plant, at least a portion of the compressed gas is cooled in the gas cooler 90 after gas compression. A bypass 130, which at one compressor of the compression stage B branches off from this compressor downstream of its gas removal line 140 and upstream of the compressor leads into its gas introduction line 150, is present at the gas compression system 80. The bypass 130 can be used to at least intermittently return at least a portion of the gas compressed in the compressor to the suction side of this compressor.

A device for spraying water into a gas stream to be compressed or into a compressor is schematically illustrated as device for the open-loop and/or closed-loop control of the water vapor content in the gas stream obtained during the gas compression. The compressors illustrated are one variable-frequency drive positive-displacement compressor 171, 171 per compressor stage.

FIG. 3 schematically shows how a gas cooler 180 is integrated in a sound suppressor 190 of a positive-displacement compressor 200. A sound suppressing part 191 is downstream of the compressing part 210 of the positive-displacement compressor 200 in the direction of the gas flow—indicated by arrow heads. The parts serving for gas cooling, such as the cooling water inlet 220, packing 230, cooling water outlet 240 and condensate outflow 250 are integrated in the sound absorber 190. The sound suppressor 190 has a cross-sectional constriction 260 for sound suppression.

Of course, it is in principle also possible for devices for computer-implemented operation of a direct reduction plant according to the invention or a method according to the invention to be present; to improve clarity, they have not been illustrated in the figures.

### LIST OF REFERENCE SIGNS

10 Direct reduction plant
20 Material containing metal oxide
30 Reduction unit
40 Reduction gas line
50 Gas compression plant
51 Gas cooler
52 Device for the open-loop and/or closed-loop control of the water vapor content
60 Catalytic reformer
70 Direct inlet
80 Gas compression plant
90 Gas cooler
100 Bypass
110 Gas introduction line
120 Gas removal line
130 Bypass
140 Gas removal line
150 Gas introduction line
160 Device for spraying water into a gas stream to be compressed or into a compressor
170 Variable-frequency-drive positive-displacement compressor
171 Variable-frequency-drive positive-displacement compressor
180 Gas cooler
190 Sound suppressor
191 Sound suppressing part
200 Positive-displacement compressor
210 Compressing part
220 Cooling water inlet
230 Packing
240 Cooling water outlet
250 Condensate outflow
260 Cross-sectional constriction

1-10. (canceled)

11. A direct reduction plant comprising: a catalytic reformer and/or a gas furnace and a gas compression plant having one or more compressors, wherein the gas compression plant comprises at least one compression stage, wherein at least one gas cooler for gas compressed in the gas compression plant is present, and wherein
a direct introduction line for introducing compressed gas directly into the reformer and/or into the gas furnace proceeds from the gas compression plant or the gas cooler with preservation of the amount of CO₂, and
at least at one of the compressors, a bypass for returning unchanged at least a portion of the gas compressed by the compressor to a suction-side gas introduction line of the relevant compressor is provided.

12. The direct reduction plant as claimed in claim 11, wherein at least one gas cooler has a bypass.

13. The direct reduction plant as claimed in claim 11, wherein the gas compression plant has a device for the open-loop and/or closed-loop control of the water vapor content in the gas stream exiting the gas compression plant.

14. The direct reduction plant as claimed in claim 11, wherein all the compressors of the gas compression plant are positive-displacement compressors.

15. The direct reduction plant as claimed in claim 11, wherein at least one positive-displacement compressor has a sound suppressor, and wherein at least one of the gas coolers is integrated in a sound suppressor of a positive-displacement compressor.

16. The direct reduction plant as claimed in claim 11, wherein the gas compression plant has one or more variable-frequency-drive positive-displacement compressors in at least one compression stage.

17. The direct reduction plant as claimed in claim 11, wherein the gas compression plant comprises at least two compression stages.

18. The direct reduction plant as claimed in claim 11, wherein the at least one gas cooler for gas compressed in the gas compression plant is present at least downstream of the last compression stage as viewed in the direction of the gas flow.

19. A method for operating a direct reduction plant comprising: a reduction unit, a catalytic reformer and/or a gas furnace and a gas compression plant, which provides compressed gas by gas compression and has one or more compressors, wherein the gas compression plant comprises at least one compression stage, wherein at least one gas cooler for gas compressed in the gas compression plant is present, wherein reduction gas is introduced into the reduction unit after gas compression, and wherein
at least a portion of the compressed gas is cooled, and compressed gas from the gas compression plant or the gas cooler is introduced directly into the reformer and/or the gas furnace with preservation of the amount of CO₂, and
at least intermittently, a portion of a gas compressed by a compressor is returned unchanged to a suction-side gas introduction line of the relevant compressor by means of the bypass.

20. The method as claimed in claim 19, wherein at least intermittently, a portion of a compressed gas conducted to a gas cooler is conveyed past the gas cooler by means of the bypass.

21. The method as claimed in claim 19, wherein the water vapor content in the gas stream obtained during the gas compression is controlled in open-loop and/or closed-loop fashion, preferably by spraying water into a gas stream to be compressed or into a compressor.

22. The method as claimed in claim 19, wherein gas is compressed in at least one compression stage by means of a variable-frequency-drive positive-displacement compressor.

23. The method as claimed in claim 19, wherein the portion of the compressed gas is cooled at least after the last gas compression as viewed in the direction of the reduction unit.

24. The method as claimed in claim 19, wherein the water vapor content in the gas stream obtained during the gas compression is controlled in open-loop and/or closed-loop fashion by spraying water into a gas stream to be compressed or into a compressor.
